(19) United States
(12) Patent Application Publication
(10) Pub. No.: US 2006/0114502 A1
(43) Pub. Date: Jun. 1, 2006

(54) Image forming device, host device and controlling methods thereof

(76) Inventors: Jea-wan Kang, Seoul (KR); Jin-hyung Kim, Suwon-si (KR)

Correspondence Address: STANZIONE & KIM, LLP, 919 18TH STREET, N.W., SUITE 440, WASHINGTON, DC, 20006, US

(21) Appl. No.: 11/288,333

(22) Filed: Nov. 29, 2005

(30) Foreign Application Priority Data
Nov. 30, 2004 (KR) 2004-99380

(51) Int. Cl. G06F 3/12

(52) U.S. Cl. 358/1.15

(57) ABSTRACT

An image forming device, a host device connected to the image forming device and controlling methods thereof. The image forming device includes a memory to store information regarding remaining recording material stored in a recording material storage medium, an image generator to generate at least one of a preview image of a document based on the remaining recording material and a color table image to display colors available in the image forming device based on the remaining recording material, and a controller to control the image generator to generate the at least one of the preview image and the color table image and to display the at least one of the preview image and the color table image on a web browser if an estimate of an amount of recording material to be consumed to print the document is greater than the remaining recording material. Accordingly, a user can prevent unwanted prints.

### CROSS-REFERENCE TO RELATED APPLICATIONS

This application claims benefit under 35 U.S.C. § 119 from Korean Patent Application No. 2004-99380, filed on Nov. 30, 2004, the disclosure of which is incorporated herein in its entirety by reference.

### BACKGROUND OF THE INVENTION

1. Field of the Invention

The present general inventive concept relates in general to an image forming device, a host device connected thereto and controlling methods thereof. More specifically, the present general inventive concept relates to a customer replaceable unit memory (CRUM) of a recording material storage medium usable with an image forming device, a host device connected thereto and controlling methods thereof.

2. Description of the Related Art

Image forming devices form (i.e., print) images corresponding to original input image data on recording media, such as printing paper. Typical examples of the image forming devices are printers, copiers, fax machines, etc.

A conventional image forming device has a recording material storage medium in the form of a customer replaceable unit, and executes printing operations using the recording material stored in the recording material storage medium. As the number of prints is increased, the recording material is gradually exhausted. However, it is not easy for a user to determine how much recording material is left in the recording material storage medium. Accordingly, it is difficult for the user to know what the printed status or the print quality is going to be based on the remaining quantity of the recording material. Therefore, unless the user sees the actual exposure of a test print, the user cannot determine the remaining quantity of the recording material. Furthermore, making a test print wastes recording material, printing paper and time.

Most application programs provide a color table so that the user can change colors in an original document by referring to the color table. If a printing operation is executed after the user changes some colors of the document according to the color table, the changes are reflected in the output of the printing. The color table provides the optimum color exposure provided that a sufficient amount of the recording material is available. This means that if the remaining quantity of the recording material is insufficient, the colors selected by the user in reference to the color table may not be printed properly. In such a case, the user has to reprint the document using a different image forming device, which resultantly wastes printing supplies including recording material and printing paper.

### SUMMARY OF THE INVENTION

The present general inventive concept provides an image forming device, a host device and controlling methods thereof, in which the image forming device provides a web browser with a preview image of a document to be printed, the preview image being generated based on usable (i.e., remaining) recording material according to a result of the comparison of an estimate of recording material consumption for the document to be printed and usable recording material that is actually available in the image forming device such that an unwanted print can be prevented.

The present general inventive concept also provides an image forming device, a host device and a controlling method thereof, in which when a color table display command is input, the image forming device provides a web browser with a color table image generated based on information regarding usable (remaining) recording material stored in a customer replaceable unit memory, thereby improving a usage efficiency of the recording material.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an image forming device to receive data of a printing document from a host device and to execute a printing operation on the printing document using recording material stored in a recording material storage medium, the device including a memory to store information regarding remaining recording material stored in the recording material storage medium, an image generator to generate at least one of a preview image of the printing document based on the remaining recording material and a color table image to display colors available in the image forming device based on the remaining recording material, and a controller to control the image generator to generate the at least one of the preview image and the color table image and to display the at least one of the preview image and the color table image on a web browser of the host device if an estimate of an amount of recording material to be consumed in the printing operation of the printing document is greater than the remaining recording material stored in the recording material storage medium.

The image forming device may further include a web server module to transmit the at least one of the preview image and the color table image to the host device in the form of a predetermined Internet language such that the image is displayable on the web browser of the host device in the form of a web page.

The memory may be a customer replaceable unit memory (CRUM) provided at a predetermined portion of the recording material storage medium.

The image forming device may further include a print engine to execute the print operation on the printing document under the control of the controller if the estimate of recording material to be consumed in the print operation of the printing document is not greater than the remaining recording material.

The foregoing and/or other aspects of the present general inventive concept are also achieved by providing an image forming device to receive data of a printing document from a host device and to execute a printing operation on the document using recording material stored in a recording material storage medium, the device including a memory to store information regarding a remaining quantity of the recording material stored in the recording material storage medium, an image generator to generate a color table image displaying colors available in the image forming device based on the remaining quantity of the recording material stored in the recording materiel storage medium, and a controller to control the image generator to generate the color table image at a color table display request received from the host device and to display the generated color table image on a web browser of the host device.

The image forming device may further include a web server module to provide the color table image to the host device in the form of a predetermined Internet language such that the color table image is displayable on the web browser of the host device in the form of a web page.

The memory may be a customer replaceable unit memory (CRUM) provided at a predetermined portion of the recording material storage medium.

The foregoing and/or other aspects of the present general inventive concept are also achieved by providing an image forming device connectable to a host device to print a document received from the host device, including a recording material storage medium to store recording material to print the document, a memory unit to store information regarding an amount of the recording material remaining in the recording material storage medium, an image generator to generate a preview image of the document based on the information regarding the amount of the recording material remaining in the recording material storage medium and to transmit the generated preview image to the host device when an estimated amount of the recording material to be used to print the document is greater than the amount of the recording material remaining in the recording material storage medium, and a print engine to print the document when the estimated amount of the recording material to be used to print the document is not greater than the amount of the recording material remaining in the recording material storage medium.

The foregoing and/or other aspects of the present general inventive concept are also achieved by providing a host device connectable to an image forming device, the host device including an estimated recording material consumption calculator to calculate an estimate of an amount of recording material to be consumed to print a document, a web browser to display at least one of a preview image of the document generated based on a remaining amount of recording material stored in the image forming device and a color table image to display colors available in the image forming device based on the remaining amount of recording material stored in the image forming device, and a controller to control the web browser to display the at least one of the preview image and the color table image in the form of a web page if the estimate of the amount of the recording material to be consumed to print the document is greater than the remaining amount of the recording material stored in the image forming device.

Information regarding the remaining amount of the recording material may be stored in a customer replaceable unit memory provided to a predetermined portion of a recording material storage medium of the image forming device.

The host device may further include an input unit to input a print confirm command based on the displayed at least one of the preview image and the color table image, wherein the controller transmits a print request signal to request printing of the document to the image forming device in response to the print confirm command.

The foregoing and/or other aspects of the present general inventive concept are also achieved by providing a host device connectable to an image forming device, the host device including an input unit to input a color table display command, a web browser to display a color table image that is generated based on a remaining amount of recording material stored in the image forming device to display colors available in the image forming device, and a controller to control the web browser to display the color table image in the form of a web page in response to the color table display command input by the input unit.

Information regarding the remaining amount of the recording material may be stored in a customer replaceable unit memory provided at a predetermined portion of a recording material storage medium of the image forming device.

The foregoing and/or other aspects of the present general inventive concept are also achieved by providing a controlling method of an image forming device to receive data of a printing document from a host device and to execute a printing operation on the printing document using recording material stored in a recording material storage medium. The controlling method includes generating at least one of a preview image of the printing document based on remaining recording material stored in the recording material storage medium and a color table image to display colors available in the image forming device based on the remaining recording material stored in the recording material storage medium, and if an estimate of an amount of recording material to be consumed in the printing operation of the document is greater than an amount of the remaining recording material stored in the recording material storage medium, controlling the generated at least one of the preview image and the color table image to be displayed on a web browser.

The controlling of the generated at least one of the preview image and the color table image to be displayed on a web browser may include comparing the estimate of the amount of the recording material to be consumed with the amount of the remaining recording material stored in the recording material storage medium, and if the estimate of the amount of the recording material to be consumed is greater than the amount of the remaining recording material stored in the recording material storage medium, providing the at least one of the preview image and the color table image to the host device in a predetermined Internet language such that the image is displayable on a web browser of the host device in the form of a web page.

If the estimate of the amount of the recording material to be consumed is not greater than the amount of the remaining recording material stored in the recording material storage medium, the method may further include executing the printing operation on the printing document.

The method may further include reading information regarding the remaining recording material from a customer replaceable unit memory provided at a predetermined portion of the recording material storage medium.

The foregoing and/or other aspects of the present general inventive concept are also achieved by providing a controlling method of an image forming device to receive data of a printing document from a host device and to execute a printing operation on the printing document using recording material stored in a recording material storage medium. The controlling method includes generating a color table image based on remaining recording material stored in the recording material storage medium to display colors available in the image forming device, and controlling the generated color table image to be displayed on a web browser.

The controlling of the generated color table image to be displayed in a web browser may include providing the color table image to the host device in the form of a predetermined Internet language such that the color table image is displayable on a web browser of the host device in the form of a web page.

The method may further include reading information regarding the remaining recording material from a customer replaceable unit memory provided at a predetermined portion of the recording material storage medium.

The foregoing and/or other aspects of the present general inventive concept are also achieved by providing a controlling method of a host device connectable to an image forming device, the method including calculating an estimate of an amount of recording material to be consumed to print a document, and if the estimated amount of the recording material to be consumed is greater than a remaining amount of recording material stored in the image forming device, displaying at least one of a preview image of the printing document generated based on the remaining recording material stored in the image forming device and a color table image to display colors available in the image forming device based on the remaining recording material stored in the image forming device.

Information regarding the remaining amount of the recording material may be stored in a customer replaceable unit memory provided at a predetermined portion of the recording material storage medium.

The method may further include if a print check command to confirm printing of the document is input based on the displayed at least one of the preview image and the color table image, transmitting a print request signal to the image forming device to control the image forming device to print the document.

The foregoing and/or other aspects of the present are also achieved by providing a controlling method of a host device connected to an image forming device, including inputting a color table display command is and displaying a color table image, which is generated based on remaining recording material stored in the image forming device to display colors available in the image forming device, on a web browser in the form of a web page in response to the input color table display command.

Information regarding the remaining recording material may be stored in a customer replaceable unit memory provided at a predetermined position of a recording material storage medium in the image forming device.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a schematic block diagram illustrating a printer and a host device according to an embodiment of the present general inventive concept;

FIG. 2 is a view illustrating an exemplary preview image according to an embodiment of the present general inventive concept;

FIG. 3 is a flow chart illustrating a method of displaying a preview image and/or a color table image in response to a print command in a host device according to an embodiment of the present general inventive concept;

FIG. 4 is a flow chart illustrating a method of displaying a preview image and/or a color table image in response to a print command in a printer according to an embodiment of the present general inventive concept;

FIG. 5 is a flow chart illustrating a method of displaying a color table image in response to a color table display command in a host device according to an embodiment of the present general inventive concept; and

FIG. 6 is a flow chart illustrating a method of displaying a color table image in response to a color table display command, in a printer according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

Hereinafter, a printer is identified as an image forming device in the embodiments of the present general inventive concept. This is to be treated as exemplary, and is not intended to limit the scope of the present general inventive concept.

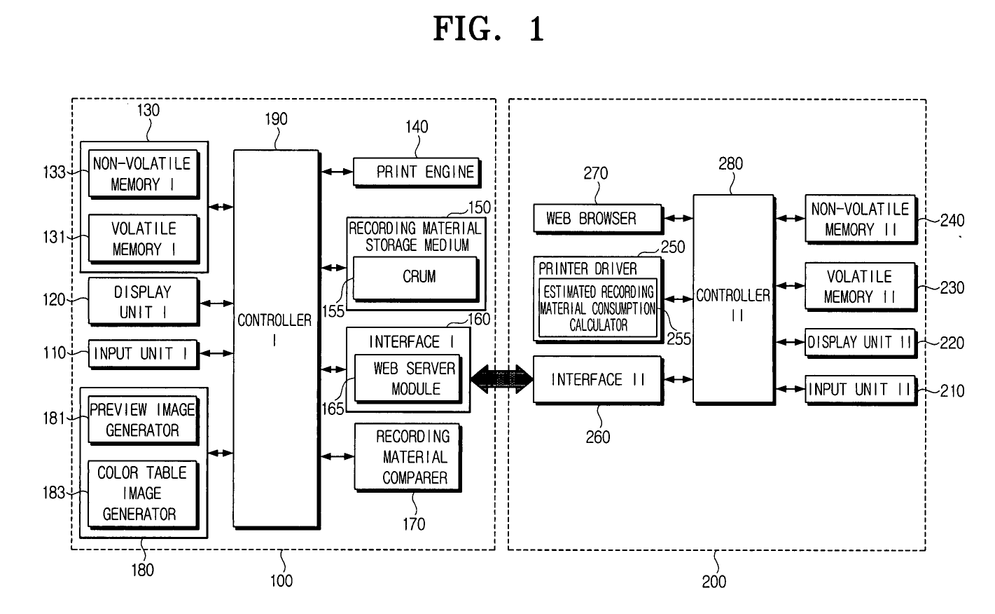

FIG. 1 is a schematic block diagram illustrating a printer 100 and a host device 200 according to an embodiment of the present general inventive concept.

Referring to FIG. 1, the printer 100 includes a first input unit 110, a first display unit 120, a first memory 130, a print engine 140, a recording material storage medium 150, a first interface 160, a recording material comparer 170, an image generator 180, and a first controller 190.

The first input unit 110 is provided with at least one operating button to allow a user to input desired commands. A user command signal input through the first input unit 110 is provided to the first controller 190, and the first controller 190 controls the printer 100 according to the user command signal.

The first display unit 120 displays notification messages for the user in response to a user command or under the control of the first controller 190.

The first memory 130 includes a first volatile memory 131 and a first non-volatile memory 133. The first volatile memory 131 temporarily stores data that is produced during the operation of the printer 100. The first non-volatile memory 133 stores first control programs to control general operations of the printer 100.

The print engine 140 executes a printing operation of a document to be printed, under the control of the first controller 190. The print engine 140 executes the printing operation using recording material stored in the recording material storage medium 150.

The recording material storage medium 150 stores the recording material that is used to print the document on printing paper. For example, toner may be used as the recording material. Accordingly, the recording material storage medium 150 may be a toner cartridge.

In a case of a black toner printer, the printer 100 only uses recording material of one color, so one recording material storage medium 150 is sufficient for the printer 100.

In a case of a color printer, the color printer 100 can also use one recording material storage medium 150. However, in this case, the recording material storage medium 150 is divided into a plurality of partitioned spaces to store recording materials of different colors. On the other hand, the color printer 100 can use a plurality of recording material storage mediums 150 to store the recording materials of the different colors, respectively.

As illustrated in FIG. 1, a customer replaceable unit memory (CRUM) 155 is provided at a designated position of the recording material storage medium 150.

The CRUM 155 stores information about a remaining quantity of the recording material. The information about the remaining quantity of the recording material is information regarding an amount of the recording material usable for subsequent prints. The CRUM 155 can also store various information, such as a number of printed pages, a printer model name, a printer serial number, a model name of the recording material storage medium 150, a product serial number of the recording material storage medium 150, information regarding various customer replaceable units applied to the printer 100, control programs of the customer replaceable units, a position of a developer provided to the printer 100, a usage frequency of the developer, and developer model information. The CRUM 155 stores the information about the remaining quantity of the recording material that is collected at regular intervals controlled by the first controller 190.

The first interface 160 communicates with the host device 200 wirelessly or wiredly.

According to the present embodiment, print data (i.e., data to be printed out) and information regarding an estimate of recording material consumption are transmitted from the host device 200 through the first interface 160. The information regarding the estimate of recording material consumption is an estimated amount of recording material to be used to print a document corresponding to the print data onto printing paper. At least one of a preview image and a color table image is transmitted to the host device 200 through the first interface 160. Also, a print request signal and a color table display request signal are transmitted from the host device 200 through the first interface 160. The preview image is an image of the document to be printed using the usable recording material remaining in the recording material recording medium 150. The color table image is a collection of colors that can be provided (or expressed) by the printer 100 based on the usable recording material remaining in the recording material recording medium 150.

The first interface 160 can include a web server module 165 to function as a web server. The web server module 165 transmits at least one of the preview image and the color table image to the host device 200 to be displayed on a web browser 270 of the host device 200. Accordingly, at least one of the preview image and the color table image is transmitted from the web server module 165 to the host device 200 in the form of an Internet language, such as HTML (hypertext markup language), XML (extensible markup language), etc.

The recording material comparer 170 compares the amount of usable recording material remaining in the recording material storage medium 150 and the information regarding the estimate of recording material consumption under the control of the first controller 190.

If the amount of the usable recording material remaining in the recording material storage medium 150 is greater than the estimated amount of the recording material to be used to print the document, the recording material comparer 170 transmits a comparison result corresponding to a sufficient amount of the usable recording material to the first controller 190. The first controller 190 then drives the print engine 140 to execute the printing operation to print the document.

On the other hand, if the amount of the usable recording material remaining in the recording material storage medium 150 is not greater than the estimated amount of the recording material to be used to print the document, the recording material comparer 170 transmits a comparison result corresponding to an insufficient amount of the usable recording material to the first controller 190. The first controller 190 controls the image generator 180 to generate at least one of the preview image and the color table image.

The image generator 180 generates the preview image and/or the color table image in the form of a web page to be displayable on the web browser 270 of the host device 200. The image generator 180 can include a preview image generator 181 and a color table image generator 183.

The preview image generator 181 generates the preview image corresponding to the print data (i.e., data to be printed out) based on the information about the remaining quantity of the recording material stored in the CRUM 155. The color table image generator 183 generates the color table image based on the information about the recording material stored in the CRUM 155.

As described above, the first controller 190 controls the printer 100 according to the first control programs stored in the first non-volatile memory 133.

The first controller 190 of this embodiment regularly collects the information about the remaining quantity of the recording material stored in the recording material storage medium 150 and updates the information in the CRUM 155.

When the print data (that is, data to be printed out) and the information regarding the estimate of recording material consumption are received through the first interface 160, the first controller 190 controls the recording material comparer 170 to compare the information about the remaining quantity of the recording material stored in the CRUM 155 with the received information regarding the estimate of recording material consumption.

If a print request signal is transmitted through the first interface 160 from the host device 200, the first controller 190 controls the print engine 140 to print the document. The print request signal can be transmitted from the host device 200 to request that the printer 100 prints the document based on the preview image or the color table image transmitted to the host device 200. Accordingly, the first controller 190 controls the print engine 140 to execute the printing operation even if the remaining recording material in the recording material storage medium 150 is insufficient.

If the color table display request signal is transmitted through the first interface 160 from the host device 200, the first controller 190 controls the color table image generator 183 to generate the color table image based on the usable recording material remaining in the recording material storage medium 150. The first controller 190 then transmits the generated color table image to the host device 200 through the first interface 160.

The host device 200 of the present embodiment includes a second input unit 210, a second display unit 220, a second volatile memory 230, a second non-volatile memory 240, a printer driver 250, a second interface 260, the web browser 270, and a second controller 280.

The second input unit 210 inputs user commands to the host device 200. The second input unit 210 can include a keyboard, a mouse, or the like. A user command signal input through the second input unit 210 is provided to the second controller 280. The second controller 280 then controls the host device 200 in response to the input user command signal.

A print command for the document to be printed can be input through the second input unit 210. Also, a print confirm command based on the preview image displayed on the web browser 270 can be input through the second input unit 210. Moreover, a color table display command can be input through the second input unit 210.

The user can also input a command through the second input unit 210 to display a print option set menu screen on the second display unit 220. When the print option set menu screen is displayed on the second display unit 220, the user can input set commands to set desired print options of the printer 100. The set commands to set the desired print options are then applied to subsequent print operations.

The second display unit 220 displays notification messages for the user in response to a user command or under the control of the second controller 280. In the present embodiment, the second display unit 220 displays the web browser 270 driven by the second controller 280.

The second volatile memory 230 temporarily stores data that is produced during operations of the host device 200.

The second non-volatile memory 240 stores second control programs to control general operations of the host device 200.

The printer driver 250 is software to convert the document into printer-readable data (i.e., the print data). The printer driver 250 provides the print option set menu screen, whereby the user can set the desired print options. The printer driver 250 can be stored in the second non-volatile memory 240. When the print command for the document is input, the printer driver 250 converts the document into the print data to be readable by the printer 100.

As illustrated in FIG. 1, the printer driver 250 includes an estimated recording material consumption calculator 255. The estimated recording material consumption calculator 255 calculates the estimated amount of the recording material to be consumed to print the document.

The second interface 260 communicates with the printer 100 wirelessly or wiredly. That is, the second interface 260 wirelessly or wiredly communicates with the first interface of the printer 160.

The print data (i.e., the data converted by the printer driver 250) and the information regarding the calculated estimate of recording material consumption are transmitted to the printer 100 through the second interface 260. At least one of the preview image and the color table image is transmitted to the host device 200 from the printer 100 through the second interface 260. Also, the print request signal and the color table display request signal are transmitted to the printer 100 through the second interface 260.

The web browser 270 is software to display information from the web server module 165 of the printer 100. The web browser 270 can be stored in the second non-volatile memory 240.

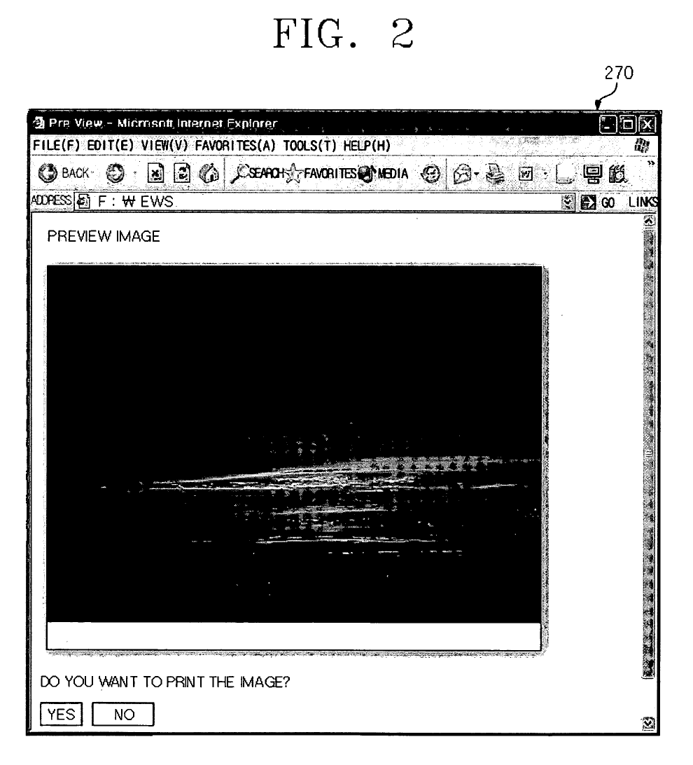

When at least one of the preview image and the color table image is transmitted from the printer 100 through the second interface 260, the web browser 270 is driven under the control of the second controller 280. The web browser 270 then displays the transmitted preview image or the color table image is displayed on the web browser 270 in the form of a web page. An example of the displayed preview image is illustrated in FIG. 2.

When the color table image is transmitted from the printer 100 through the second interface 260 in response to the color table display command, the web browser 270 is driven under the control of the second controller 280 to display the transmitted color table image in the form of a web page.

As described above, the second controller 280 controls the general operations of the host device 200 according to the second control programs stored in the second non-volatile memory 240.

When the print confirm command is input through the second input unit 210, the second controller 280 generates the print request signal and transmits the generated print request signal to the printer 100 through the second interface 260. That is, if the preview image is displayed when an insufficient amount of recording material remains in the recording material storage medium 150 of the printer 100, the user can input the print confirm command to request printing of a document corresponding to the preview image. Accordingly, the print request signal is sent to the printer 100, and the printer 100 prints the document even though there is an insufficient amount of recording material remaining in the recording material storage medium.

If the color table display command is input through the second input unit 210, the second controller 280 generates the color table display request signal and transmits the color table request signal to the printer 100 through the second interface 260.

FIG. 2 illustrates an exemplary preview image according to operations performed in FIG. 1 as described above.

Referring to FIGS. 1 and 2, the preview image generated by the preview image generator 181 of the printer 100 is transmitted to the host device 200, and the web browser 270 is driven under the control of the second controller 280 of the host device 200. The web browser 270 then displays the preview image in the form of a web page.

As illustrated in FIG. 2, the web browser 270 suggests a web server, such as ‘F:\EWS,’ to provide a web page. In this embodiment, ‘F:\EWS’ indicates the web server module 165 in the first interface 160 of the printer. A title, such as ‘Preview Image,’ can be displayed above the preview image to let the user know that the displayed image is a preview image. As described above, the preview image generator 181 generates the preview image using the information about the remaining quantity of the recording material stored in the CRUM 155. A question to determine whether the user wants to print the displayed preview image as it is can be displayed below the preview image. By clicking or selecting a displayed button ‘Yes’ or ‘No’, the user can decide whether to print the preview image as it is displayed. For example, the user can select ‘Yes’ to input the print confirm command described above.

The web browser 270, as illustrated in FIG. 2, is provided as an example and thus, the scope of the present general inventive concept is not to be limited thereto.

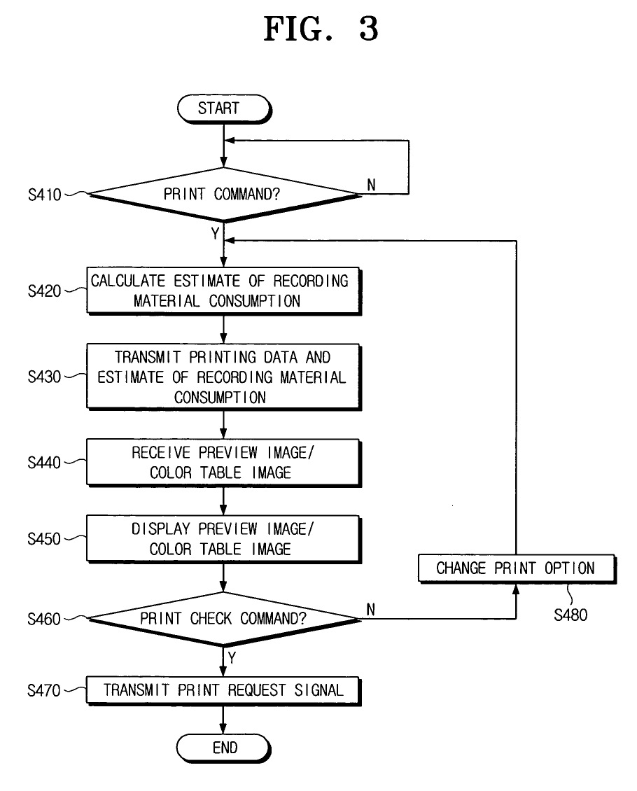

FIG. 3 is a flow chart illustrating a method of displaying the preview image and/or the color table image in response to the print command in the host device 200 according to an embodiment of the present general inventive concept.

Referring to FIGS. 1 and 3, when the user inputs the print command through the second input unit 210 (operation S410), the print document (that is, the document to be printed out) is converted into the print data by the printer driver 250, and the estimated recording material consumption calculator 255 calculates the estimated amount of recording material to be used to print the document (operation S420). The print data and the information regarding the calculation of the estimated recording material consumption are provided to the printer 100 through the second interface 260 (operation S430).

When at least one of the preview image and the color table image is transmitted from the printer 100 through the second interface 260 (operation S440), the web browser 270 is driven by the second controller 280 to display the transmitted image (either the preview image or the color table image) in the form of a web page (operation S450).

The user can then input the print confirm command to confirm that the image (either the preview image or the color table image) displayed on the web browser is to be printed. Accordingly, it is determined whether the print confirm command is input through the second input unit 210 (operation S460). If the print confirm command is input, the print request signal is generated under the control of the second controller 280 and transmitted to the printer 100 (operation S470).

On the other hand, if the print confirm command is not input, the print option set menu screen can be displayed on the second display unit 220 to allow the user to make changes in the image (either the preview image or the color table image) displayed on the web browser. The user can then change the print options by setting new print options on the displayed print option set menu screen (operation S480).

Once the new print options are set by the user, operations S420, S430, S440, S450, and S460 are repeated.

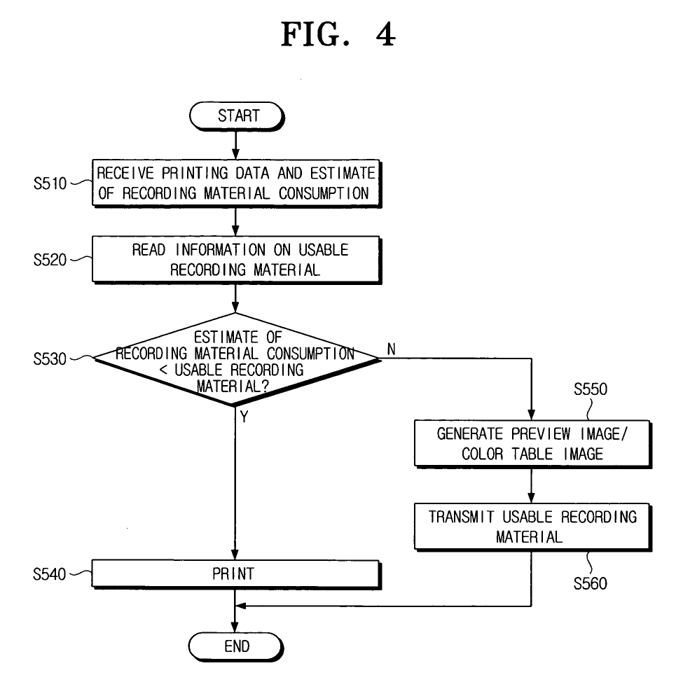

FIG. 4 is a flow chart illustrating a method of displaying the preview image and/or the color table image in the printer 100 in response to a print command according to an embodiment of the present general inventive concept.

Referring to FIGS. 1 and 4, when the print data (that is, data to be printed out) and the information regarding the estimate of recording material consumption are provided from the host device 200 (operation S510), the information about the remaining quantity of the recording material is read from the CRUM 155 under the control of the first controller 190 (operation S520).

The recording material comparer 170 then compares the amount of the usable recording material remaining in the recording material storage medium 150 and the estimated amount of the recording material to be used to print the print data (operation S530).

If the amount of the usable recording material remaining in the recording material storage medium 150 is greater than the estimated amount of the recording material to be used, the printing operation is executed for the received print data under the control of the first controller 190 (operation S540).

In contrast, if the amount of the usable recording material remaining in the recording material storage medium 150 is not greater than the estimated amount of the recording material to be used, the image generator 180 generates the preview image and/or the color table image based on the amount of the usable recording material remaining in the recording material storage medium 150 (operation S550). The generated image (either the preview image or the color table image) is then transmitted to the host device 200 through the first interface 160 (operation S560).

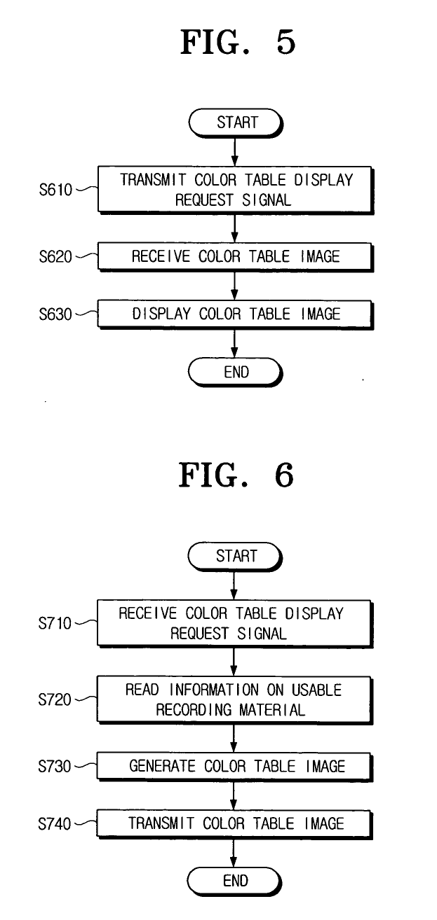

FIG. 5 is a flow chart illustrating a method of displaying the color table image in response to the color table display command in the host apparatus 200 according to an embodiment of the present general inventive concept.

Referring to FIGS. 1 and 5, when the user inputs the color table display command through the second input unit 210, the color table display request signal is generated under the control of the second controller 280 and transmitted to the printer 100 through the second interface 260 (operation S610).

The color table image is then received from the printer 100 (operation S620), and the web browser 270 is driven by the second controller 280 to display the received color table image in the web browser 270 in the form of a web page (operation S630).

FIG. 6 is a flow chart a method of generating the color table image in the printer 100 in response to the color table display command according to an embodiment of the present general inventive concept.

Referring to FIGS. 1, 5 and 6, when the color table display request signal is received from the host device 200 (operation S710), the information about the remaining quantity of the recording material is read from the CRUM 155 under the control of the first controller 190 (operation S720).

The control of the first controller 190 then controls the color table image generator 183 to generate the color table image based on the read information about the remaining quantity of the recording material (operation S730). The generated color table image is then transmitted to the host device 200 through the first interface 160 under the control of the first controller (operation S740).

As illustrated in the embodiments above, the information about the remaining quantity of the usable recording material is collected and stored in the CRUM 155. However, the information can also be collected and stored in the non-volatile memory 133. It is clear that the scope of the disclosure includes the aforementioned modification.

In addition, the color table display command can be input not only through the second input unit 210 of the host device 200 as explained above, but also through the first input unit 110 of the printer 100. Again, this modification is included in the scope of the disclosure.

As described above, an image forming device, a host device, and controlling methods thereof according to various embodiments of the present general inventive concept can be advantageously used to prevent unwanted prints by providing a user with a preview image and a color table image corresponding to printing data that are generated corresponding to an amount of usable (i.e., remaining) recording material according to a result of a comparison of an estimated amount of recording material to be used to print a document with the amount of usable recording material that is actually stored in a recording material storage medium. Accordingly, by preventing unwanted prints, it is possible to conserve customer replaceable units and to save time. In addition, since a user is able to change print options of a document based on a preview image, a desired print can be obtained.

Moreover, when a color table display command is input, a user is provided with a color table image to display colors available in the image forming device using remaining recording material. Accordingly, it is possible to conserve customer replaceable units and to save time, and a desired print can be obtained.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming device to receive data of a printing document from a host device and to execute a printing operation on the printing document using recording material stored in a recording material storage medium, the device comprising:
a memory to store information regarding remaining recording material stored in the recording material storage medium;
an image generator to generate at least one of a preview image of the printing document based on the remaining recording material and a color table image to display colors available based on the remaining recording material; and
a controller to control the image generator to generate the at least one of the preview image and the color table image and to display the at least one of the preview image and the color table image on a web browser of the host device if an estimate of an amount of recording material to be consumed in the printing operation of the printing document is greater than the remaining recording material stored in the recording material storage medium.

2. The device according to claim 1, further comprising:
a web server module to provide the at least one of the preview image and the color table image to the host device in the form of a predetermined Internet language such that the image is displayable on the web browser of the host device in the form of a web page.

3. The device according to claim 1, wherein the memory comprises a customer replaceable unit memory (CRUM) provided at a predetermined portion of the recording material storage medium.

4. The device according to claim 1, further comprising:
a print engine to execute a print operation on the printing document under the control of the controller if the estimate of the amount of the recording material to be consumed in the printing operation of the printing document is not greater than the remaining recording material.

5. An image forming device to receive data of a printing document from a host device and to execute a printing operation on the printing document using recording material stored in a recording material storage medium, the device comprising:
a memory to store information regarding a remaining quantity of the recording material stored in the recording material storage medium;
an image generator to generate a color table image displaying colors available in the image forming device based on the remaining quantity of the recording material stored in the recording material storage medium; and
a controller to control the image generator to generate the color table image at a color table display request and to control the generated color table image to be displayed on a web browser of the host device.

6. The device according to claim 5, further comprising:
a web server module to provide the color table image to the host device in the form of a predetermined Internet language such that the color table image is displayable on the web browser of the host device in the form of a web page.

7. The device according to claim 5, wherein the memory comprises a customer replaceable unit memory (CRUM) provided at a predetermined portion of the recording material storage medium.

8. An image forming device connectable to a host device to print a document received from the host device, comprising:
a recording material storage medium to store recording material to print the document;
a memory unit to store information regarding an amount of the recording material remaining in the recording material storage medium;
an image generator to generate a preview image of the document based on the information regarding the amount of the recording material remaining in the recording material storage medium and to transmit the generated preview image to the host device when an estimated amount of the recording material to be used to print the document is greater than the amount of the recording material remaining in the recording material storage medium; and
a print engine to print the document when the estimated amount of the recording material to be used to print the document is not greater than the amount of the recording material remaining in the recording material storage medium.

9. The image forming device according to claim 8, wherein the image generator generates the preview image using a predetermined Internet language and transmits the preview image to the host device to be displayable on a web browser of the host device.

10. The image forming device according to claim 8, further comprising:
a color table image generator to generate a color table image to display colors available based on the amount of the recording material remaining in the recording material storage medium and to transmit the generated color table image to the host device.

11. The image forming device according to claim 8, wherein when the estimated amount of the recording material to be used to print the document is greater than the amount of the recording material remaining in the recording material storage medium and a print confirmation signal is received from the host device based on the generated preview image, the print engine prints the preview image generated by the image generator.

12. The image forming device according to claim 8, wherein the memory unit updates the stored information at regular intervals.

13. The image forming device according to claim 8, wherein the estimated amount of the recording material to be used to print the document is input from the host device.

14. A host device connected to an image forming device, the host device comprising:
an estimated recording material consumption calculator to calculate an estimate of an amount of recording material to be consumed to print a document;
a web browser to display at least one of a preview image of the document generated based on a remaining quantity of recording material stored in the image forming device and a color table image to display colors available in the image forming device based on the remaining quantity of the recording material stored in the image forming device; and
a controller to control the web browser to display the at least one of the preview image and the color table image in the form of a web page if the estimate of the amount of the recording material to be consumer to print the document is greater than the remaining quantity of the recording material stored in the image forming device.

15. The host device according to claim 14, wherein information regarding the remaining quantity of the recording material is stored in a customer replaceable unit memory provided at a predetermined portion of a recording material storage medium of the image forming device.

16. The host device according to claim 14, further comprising:
an input unit to input a print confirm command based on the displayed at least one of the preview image and the color table image, wherein the second controller transmits a print request signal corresponding to the document to the image forming device in response to the print confirm command input by the input unit.

17. A host device connected to an image forming device, the host device comprising:
an input unit to input a color table display command;
a web browser to display a color table image that is generated based on a remaining quantity of recording material stored in the image forming device and displays colors available in the image forming device; and
a controller to control the web browser to display the color table image in the form of a web page in response to the color table display command input by the input unit.

18. The host device according to claim 17, wherein information regarding the remaining quantity of the recording material is stored in a customer replaceable unit memory provided at a predetermined portion of a recording material storage medium of the image forming device.

19. A controlling method of an image forming device to receive data of a printing document from a host device and to execute a printing operation on the printing document using recording material stored in a recording material storage medium, the controlling method comprising:
generating at least one of a preview image of the printing document based on remaining recording material stored in the recording material storage medium and a color table image to display colors available in the image forming device based on the remaining recording material stored in the recording material storage medium; and
if an estimate of an amount of recording material to be consumed in the printing operation of the printing document is greater than an amount of the remaining recording material, controlling the generated at least one of the preview image and the color table image to be displayed on a web browser.

20. The method according to claim 19, wherein the controlling step of the generated at least one of the preview image and the color table image to be displayed on a web browser comprises:
comparing the estimate of the amount of the recording material to be consumed with the amount of the remaining recording material; and
if the estimate of the amount of the recording material to be consumed is greater than the amount of remaining recording material, providing the at least one of the preview image and the color table image to the host device in a predetermined Internet language such that the image is displayable on a web browser of the host device in the form of a web page.

21. The method according to claim 20, further comprising:
if the estimate of the amount of the recording material to be consumed is not greater than the amount of the remaining recording material, executing the printing operation on the printing document.

22. The method according to claim 19, further comprising:
reading information on the remaining recording material from a customer replaceable unit memory provided at a predetermined portion of the recording material storage medium.

23. A controlling method of an image forming device to receive data of a printing document from a host device and to execute a printing operation on the printing document using recording material stored in a recording material storage medium, the controlling method comprising:
generating a color table image based on remaining recording material stored in the recording material storage medium to display colors available in the image forming device; and
controlling the generated color table image to be displayed on a web browser.

24. The method according to claim 23, wherein the controlling of the generated color-table image to be displayed on a web browser comprises:
providing the color table image to the host device in the form of a predetermined Internet language such that the color table image is displayable on a web browser of the host device in the form of a web page.

25. The method according to claim 23, further comprising:
reading information on the remaining recording material from a customer replaceable unit memory provided at a predetermined portion of the recording material storage medium.

26. A controlling method of a host device connected to an image forming device, the method comprising:
calculating an estimate of an amount of recording material to be consumed to print a document; and
if the estimated recording material consumption is greater than an amount of remaining recording material stored in the image forming device, displaying at least one of a preview image of the printing document generated based on the remaining recording material in the image forming device and a color table image to display colors available in the image forming device based on the remaining recording material.

27. The method according to claim 26, wherein information on the remaining recording material is stored in a customer replaceable unit memory provided at a predetermined portion of a recording material storage medium of the image forming device.

28. The method according to claim 26, further comprising:
if a print check command to confirm printing of the document is input based on the displayed at least one of the preview image and the color table image, transmitting a print request signal to the image forming device to control the image forming device to print the document.

29. A controlling method of a host device connected to an image forming device, comprising:
inputting a color table display command; and
displaying a color table image, which is generated based on remaining recording material stored in the image forming device to display colors available in the image forming device, on a web browser in the form of a web page in response to the input color table display command.

30. The method according to claim 29, wherein information of the remaining recording material is stored in a customer replaceable unit memory provided at a predetermined portion of a recording material storage medium in the image forming device.
